(19) United States
(12) Patent Application Publication
(10) Pub. No.: US 2005/0283770 A1
(43) Pub. Date: Dec. 22, 2005

(54) Detecting memory address bounds violations

(76) Inventors: Alan H. Karp, Palo Alto, CA (US); Jean-Francois C. Collard, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/871,971

(22) Filed: Jun. 18, 2004

(51) Int. Cl. G06F 9/45

(52) U.S. Cl. 717/151

(57) ABSTRACT

In one aspect, machine-executable code is generated. The machine-executable code includes machine-readable instructions for detecting a memory address bounds violation by the program code based on a determination that a boundary memory address stored in a hardware table has been accessed during execution of the program code. The boundary memory address delimits a boundary for a set of memory addresses allocated for execution of the program code. The machine-executable code is stored in a machine-readable medium. In another aspect, a boundary memory address delimiting a boundary for a set of memory addresses allocated for execution of the program code is stored in a hardware table. The program code is executed. A memory address bounds violation by the program code is detected based on a determination that the boundary memory address stored in the hardware table has been accessed during execution of the program code.

### BACKGROUND

A buffer overflow occurs when a program or process tries to store more data in a buffer (temporary data storage area) than it was intended to hold. When a program writes past the bounds of a buffer, the extra data typically overflows into one or more adjacent buffers, corrupting or overwriting the valid data held in the adjacent buffers. Buffer overflow often occurs as a result programming error. Buffer overflow also is exploited by malicious code developers to bypass standard intrusion security measures and attack computer systems.

There are four general types of buffer overflow avoidance techniques: secure coding; non-executable stacks; array bounds checking; and pointer integrity checking. Only array bounds checking, however, can provide complete protection against all forms of buffer overflow risks. Some compilers introduce a software bounds check before each array reference. The bound check verifies the lower and upper bounds of an array subscript expression. If a bounds violation is detected, program execution is terminated and an error is reported. This type of complete array bounds checking, however, is difficult to implement and requires a high overhead that significantly slows system performance.

### SUMMARY

In one aspect, the invention features a machine-implemented method of processing program code in accordance with which machine-executable code is generated. The machine-executable code includes machine-readable instructions for detecting a memory address bounds violation by the program code based on a determination that a boundary memory address stored in a hardware table has been accessed during execution of the program code. The boundary memory address delimits a boundary for a set of memory addresses allocated for execution of the program code. The machine-executable code is stored in a machine-readable medium.

The invention also features a machine-readable medium storing machine-readable instructions for causing a machine to implement the inventive program code processing method described above.

In another aspect, the invention features a machine-implemented method of processing program code in accordance with which a boundary memory address delimiting a boundary for a set of memory addresses allocated for execution of the program code is stored in a hardware table. The program code is executed. A memory address bounds violation by the program code is detected based on a determination that the boundary memory address stored in the hardware table has been accessed during execution of the program code.

Other features and advantages of the invention will become apparent from the following description, including the drawings and the claims.

### DESCRIPTION OF DRAWINGS

FIG. 1 is a block diagram of an embodiment of a data processing system.

FIG. 2 is a block diagram of an embodiment of a processing unit of the data processing system shown in FIG. 1.

FIG. 3 shows a data pipeline that includes program code that is being processed by the data processing system embodiment of FIG. 1 into machine-executable code.

FIG. 4 is a flow diagram of an embodiment of a method of processing program code.

FIG. 5 is a flow diagram of an embodiment of a method of generating machine-readable instructions for detecting a memory bounds violation.

FIG. 6 is a diagrammatic view of a pair of registers containing a set of memory addresses allocated for executing program code.

FIG. 7 is a flow diagram of an embodiment of a method of executing machine-executable code containing machine-readable instructions for detecting a memory bounds violation.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

The bounds checking embodiments described in detail below leverage the data speculation hardware functionality present in modern computer processor designs to detect array bounds violations. In this way, these bounds checking embodiments avoid the performance penalties associated with software-based bounds checking schemes that check the value of every array access or that only load as much data as will fit in a designated buffer. In addition, the bounds checking embodiments described herein can detect memory address bounds violations from a calling routine in a program.

Data speculation is a process that a compiler uses to load data earlier than originally scheduled. In this way, the data required by an instruction will be available in a register when it is needed, thereby reducing or avoiding memory latency delays. Data speculation is enabled by processor instruction sets that include advanced load instructions. For example, the Intel IA-64 architecture uses an instruction called an advanced load that is executed by the processor earlier in the instruction stream than a corresponding original load instruction. In particular, the advanced load of the value at some address A may be executed before a write to potentially the same address A. When executed, an advanced load allocates an entry in a hardware structure called the advanced load address table (ALAT), which is managed by hardware. The load address, the load type and the size of the load are stored in the ALAT register. A compiler typically inserts a load checking instruction at the instruction stream location of the original load instruction to validate the advanced load entry in the ALAT. The load checking instruction specifies the same register number, address and operand size as the corresponding advanced load instruction. When executed, the load checking operation searches the ALAT for a matching entry. If the matching entry is found, the value in the destination register is valid. If no matching entry is found, for instance if the intervening write did store at address A, the value loaded in the destination register is invalid and the required data may be reloaded from memory or some other recovery routine may be initiated depending on the type of load checking instructions is used.

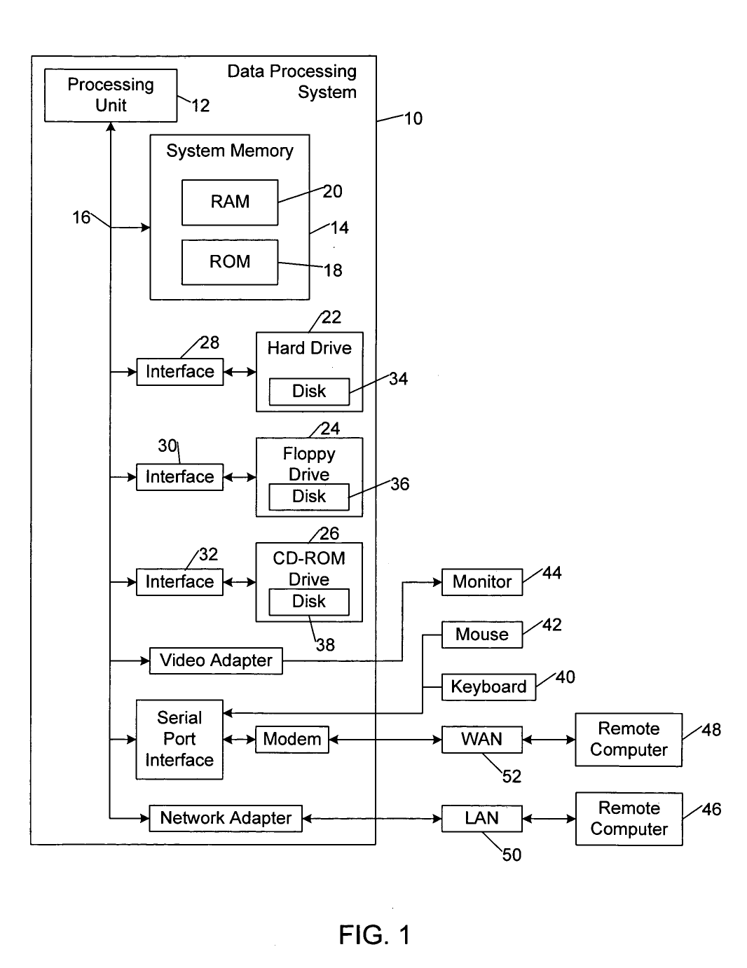

FIG. 1 shows a data processing system 10 that may embody and implement one or more of the bounds checking embodiments described herein. The data processing system 10 includes a processing unit 12, a system memory 14, and a system bus 16 that couples processing unit 12 to the various components of data processing system 10. Processing unit 12 may include one or more processors, each of which may be in the form of any one of various commercially available processors that provide some form of data speculation functionality. System memory 14 includes a read only memory (ROM) 18 that stores a basic input/output system (BIOS) containing start-up routines for data processing system 10, and a random access memory (RAM) 20. System bus 16 may be a memory bus, a peripheral bus or a local bus, and may be compatible with any of a variety of bus protocols, including PCI, VESA, Microchannel, ISA, and EISA. Data processing system 10 also includes a hard drive 22, a floppy drive 24, and CD ROM drive 26 that are connected to system bus 16 by respective interfaces 28, 30, 32. Hard drive 22, floppy drive 24, and CD ROM drive 26 contain respective computer-readable media disks 34, 36, 38 that provide non-volatile or persistent storage for data, data structures and computer-executable instructions. Other computer-readable storage devices (e.g., magnetic tape drives, flash memory devices, and digital video disks) also may be used with data processing system 10. A user may interact (e.g., enter commands or data) with data processing system 10 using a keyboard 40 and a mouse 42. Other input devices (e.g., a microphone, joystick, or touch pad) also may be provided. Information may be displayed to the user on a monitor 44. Data processing system 10 also may include peripheral output devices, such as speakers and a printer. Data processing system 10 may be connected to remote computers 46, 48, which may be workstations, server computers, routers, peer devices or other common network nodes. Remote computer 46 may be connected to data processing system 10 over a local area network (LAN) 50, and remote computer 48 may be networked over a wide area network (WAN) 52 (e.g., the internet).

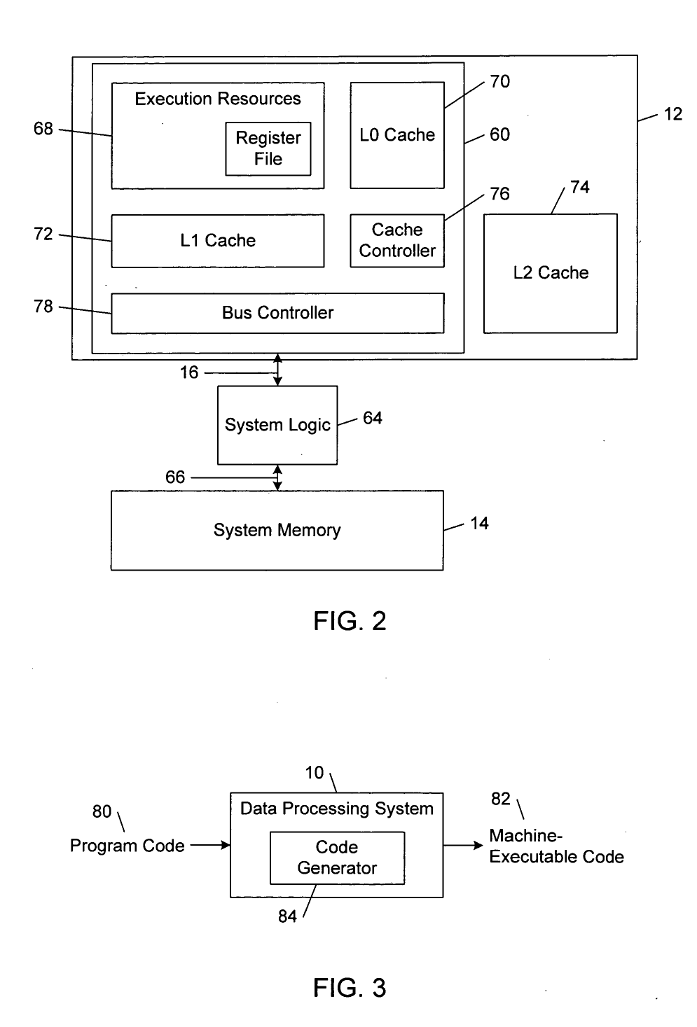

FIG. 2 shows an embodiment of processing unit 12 that is suitable for implementing the bounds checking embodiments described in detail below. Processing unit 12 includes a processor 60 that is connected by system bus 16 to a system logic module 64, which is connected to system memory 14 by a memory bus 66. Processing unit 12 includes a set of execution resources 68, an L0 cache 70, an L1 cache 72, an L2 cache 74, a cache controller 76, and a bus controller 78. Processor 60 may include logic elements for retrieving instructions, processing instructions, and updating the processor state. Processor 60 is operable to process advanced load instructions and advanced check instructions. Bus controller 78 manages the flow of data between processor 60 and system memory 14 and the flow of data between processor 60 and L2 cache 74, which is located on a different chip than processor 60 in the illustrated embodiment.

The execution resources 68 receives data and instructions from the various memory cache 70-74 and the system memory 14, which are arranged in a memory hierarchy with lower cache levels being closer to the processor core. Load and store operations respectively transfer data to and from register files. A load operation searches the memory hierarchy for data at a specified memory address, and returns the data to a register file, whereas a store operation writes data from a register file to one or more levels of the memory hierarchy.

FIG. 3 shows a data pipeline by which data processing system 10 processes program code 80 into machine-executable code 82 that detects memory address bounds violations in a way that leverages the data speculation functionality of processing unit 12. In particular, the processing system 10 executes a code generator 84 that generates machine-readable instructions corresponding to the program code 80, as well as data-speculation-based bounds checking instructions, and stores the machine-readable instructions as machine-executable code 82 on a machine-readable medium (e.g., one or more of RAM 20 and disks 34-38 shown in FIG. 1). Program code 80 may correspond to a complete program, a segment of a computer program, or a stream of program instructions. In general, the code generator 84 is not limited to any particular hardware or software configuration, but rather it may be implemented in any computing or processing environment, including in digital electronic circuitry or in computer hardware, firmware, device driver, or software. In some implementations, the code generator 84 may be a compiler, a program translation system, or a suitable run-time system that transforms program code 80 into a machine-executable form (e.g., machine language).

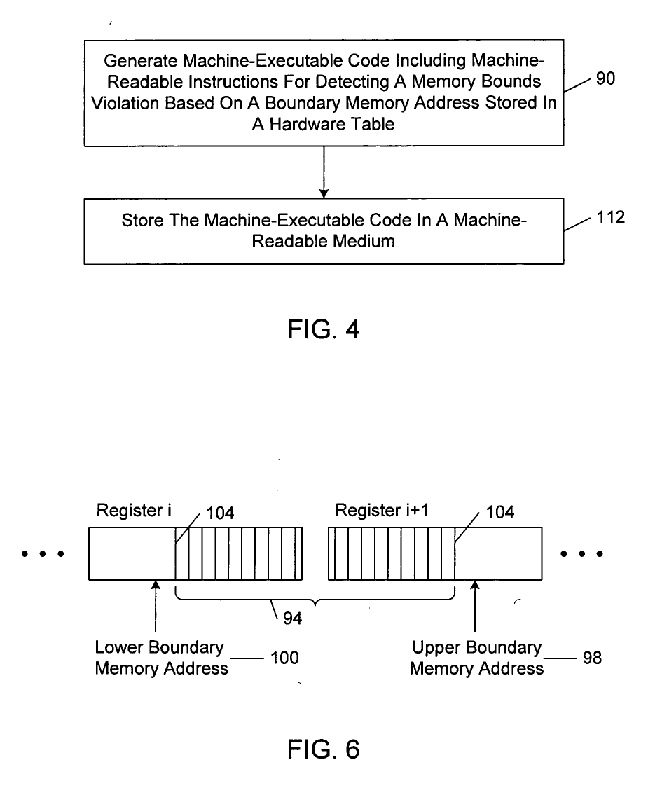

FIG. 4 shows an embodiment of a method by which code generator 84 processes program code 80. Code generator 84 generates machine-executable code including machine-readable instructions for detecting a memory address bounds violation by the program code based on a boundary memory address stored in a hardware table (block 90). The hardware table is stored in and managed by hardware. The code generator 84 typically preprocesses the program code 80. During the preprocessing stage, the code generator 84 performs tasks specified by any preprocessor statements (or directives) in the program code 80, such as reading in header files, defining constants, and evaluating expressions. After the preprocessing stage, the code generator 84 translates the program code 80 and header files into a machine-readable equivalent assembly language file (or object file). The code generator 84 then begins a linking stage, during which the object file and any associated object library files are combined into a single program object file. In addition, during the linking stage the code generator resolves external references, searches libraries, and performs other processing tasks to produce an object module that is ready for execution. The code generator 84 further processes the resulting object module to produce the machine-executable code 82, which then may be loaded into memory.

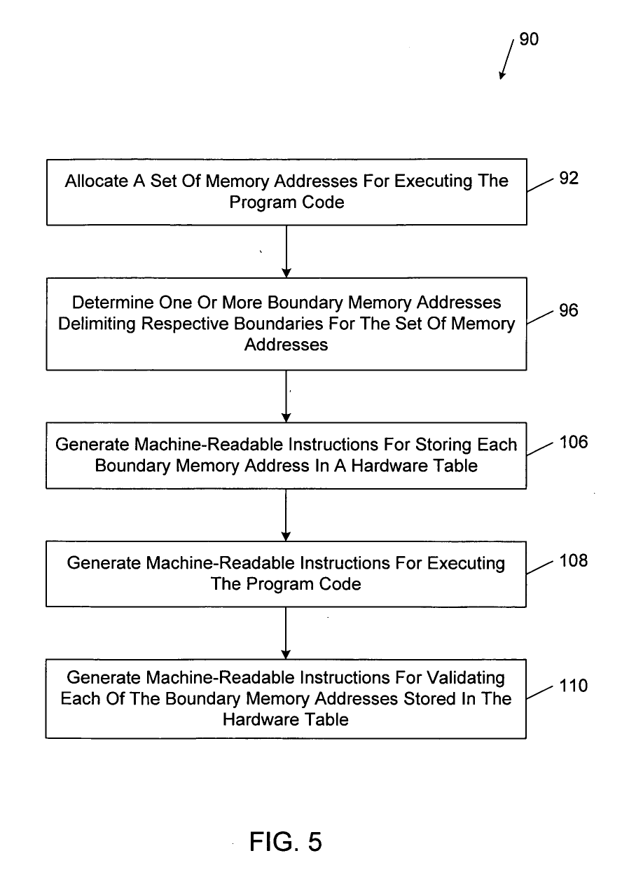

FIG. 5 shows an implementation of the machine-executable code generation process of block 90. In accordance with this implementation, the code generator 84 allocates a set of memory addresses for executing the program code 80 (block 92). The memory address allocation process may occur, for example, during the stage of the code generation process when a specific (usually contiguous) set of memory addresses is allocated by the code generator 84 for the execution of the program code 80. As shown in FIG. 6, the set of allocated memory addresses 94 typically corresponds to a set of contiguous memory addresses in one or more application registers (e.g., Register i and Register i+1) that are designated for use by application programs.

The code generator 84 determines one or more boundary memory addresses delimiting respective boundaries for the set of memory addresses (block 96). As shown in FIG. 6, the set of allocated memory addresses 94 is bounded at an upper end by an upper boundary memory address 98 and is bounded at a lower end by a lower boundary memory address 100. In particular, the upper boundary memory address 98 is located above a maximum memory address 102 in set 94 and the lower boundary memory address 98 is located below a minimum memory address 104 in set 94. The upper and lower boundary memory addresses 98, 100 may be located immediately adjacent to the maximum and minimum memory addresses 102, 104, respectively, or they may be spaced-apart from the maximum and minimum memory addresses 102, 104 by one or more buffer memory addresses. In some implementations, more than one upper boundary memory address and more than one lower boundary memory address are determined in block 96.

After the one or more boundary memory addresses have been determined (block 96), the code generator 84 generates machine-readable instructions for storing each of the boundary memory addresses in a hardware table (block 106). Code generator 84 generates machine-readable instructions for executing the program code 80 (block 108). Code generator 84 also generates machine-readable instructions for validating each of the boundary memory addresses stored in the hardware table (block 110).

For example, assume that a contiguous chunk of memory with addresses ranging from 4 to 8 is allocated by the code generator 84 for a particular program code 80. In this example, the code generator 84 determines that the upper and lower boundary memory addresses are 9 and 3, which are adjacent to the maximum and minimum addresses in the allocated memory range. In one exemplary implementation that is compatible with the Intel IA-64 architecture, the code generator 84 generates the following sequence of machine-readable instructions in accordance with the memory of FIG. S. An address is inserted into the hardware table by the ld.a instructions. Any store instruction to that address removes the entry from the table. A subsequent check instruction determines if the entry is in the hardware table.

ld.a [3]
ld.a [9]

{beginning of machine-readable instructions
corresponding to program code 80 . . .
. . . end of machine-readable instructions
corresponding to program code 80}

ld.c [3], target
ld.c [9], target

In this implementation, the machine-readable instruction “ld.a [x]” is an advanced load instruction that loads the memory address x into the ALAT hardware table. The machine-readable instruction “ld.c [x], target” is a speculation (or advanced) check instruction that validates the boundary memory address x stored in the ALAT hardware table. The speculation check instruction tests to determine whether a store has occurred to the address contained in the hardware table. Since the addresses being checked are outside the specified bounds, the absence of the address denotes a bounds violation. The code then branches to the address specified by “target” to take remedial action.

In the code example presented above, if the machine-readable instructions corresponding to program code 80 stores to memory address 3, then memory address 3 is removed from the ALAT hardware table and the corresponding “ld.c [3]” ALAT entry check fails. Similarly, if the machine-readable instructions corresponding to program code 80 stores to memory address 9, then memory address 9 is removed from the ALAT hardware table and the corresponding “ld.c [9]” ALAT entry check fails.

Referring back to FIG. 4, after the machine-readable instructions for detecting a memory bounds violation have been generated (block 90), the code generator 84 stores the resulting machine-executable code in a machine-readable medium (block 112).

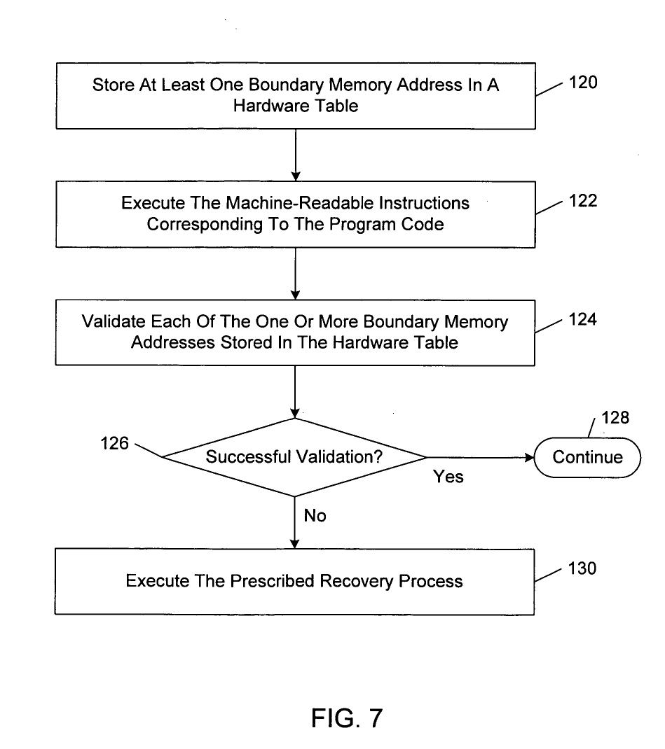

FIG. 7 shows a flow diagram of an embodiment of a method by which processor 60 executes that machine-executable code 82 that is generated by code generator 84 from program code 80. In accordance with this method, at least one boundary memory address is stored in a hardware table, such as the ALAT table in the Intel IA-64 architecture (block 120). For example, one or both of the upper and lower boundary memory addresses 98, 100 may be loaded into the ALAT table using the Intel IA-64 “ld.a” instruction. The machine-readable instructions corresponding to the program code 80 is executed (block 122). Each of the one or more boundary memory addresses that are stored in the hardware table is validated (block 124). For example, the boundary memory addresses may be validated using the Intel IA-64 “ld.c” instruction. If all of the boundary memory addresses stored in the hardware table are determined to be valid (block 126), the normal code execution process continues (block 128). If any of the boundary memory addresses is determined to be invalid (block 126), the processor 60 executes a prescribed recovery process (block 130). For example, the processor 60 may branch to the recovery process specified by the “target” operand in the corresponding “ld.c” instruction that identified the boundary memory violation.

In some current implementations of the Intel IA-64 architecture, the ALAT hardware table is not part of the state of a process and entries may be removed at any time. When used to embody or implement the bounds checking embodiments described herein, the Intel IA-64 architecture should be modified so that use of the ALAT is deterministic. In this regard, the instruction set may be modified to include an additional bit that denotes that an entry in the ALAT is part of the process state to be saved and restored across context switches and that such an entry may not be replaced, only explicitly cleared.

Other embodiments are within the scope of the claims. For example,

The systems and methods described herein are not limited to any particular hardware or software configuration, but rather they may be implemented in any computing or processing environment, including in digital electronic circuitry or in computer hardware, firmware, or software. In general, the systems may be implemented, in part, in a computer process product tangibly embodied in a machine-readable storage device for execution by a computer processor. In some embodiments, these systems preferably are implemented in a high level procedural or object oriented processing language; however, the algorithms may be implemented in assembly or machine language, if desired. In any case, the processing language may be a compiled or interpreted language. The methods described herein may be performed by a computer processor executing instructions organized, for example, into process modules to carry out these methods by operating on input data and generating output. Suitable processors include, for example, both general and special purpose microprocessors. Generally, a processor receives instructions and data from a read-only memory and/or a random access memory. Storage devices suitable for tangibly embodying computer process instructions include all forms of non-volatile memory, including, for example, semiconductor memory devices, such as EPROM, EEPROM, and flash memory devices; magnetic disks such as internal hard disks and removable disks; magneto-optical disks; and CD-ROM. Any of the foregoing technologies may be supplemented by or incorporated in specially designed ASICs (application-specific integrated circuits).

1. A machine-implemented method of processing program code, comprising:
generating machine-executable code including machine-readable instructions for detecting a memory address bounds violation by the program code based on a determination that a boundary memory address stored in a hardware table has been accessed during execution of the program code, wherein the boundary memory address delimits a boundary for a set of memory addresses allocated for execution of the program code; and
storing the machine-executable code in a machine-readable medium.

2. The method of claim 1, wherein the hardware table is designed to contain memory addresses of speculative loads.

3. The method of claim 1, wherein the machine-readable instructions include an instruction for storing the boundary memory address in the hardware table.

4. The method of claim 3, wherein the storage instruction is an advanced load instruction.

5. The method of claim 3, wherein the machine-readable instructions specify storage of the boundary memory address before the program code is executed.

6. The method of claim 1, wherein the machine-readable instructions include an instruction for validating the boundary memory address stored in the hardware table.

7. The method of claim 6, wherein the validation instruction is an advanced load check instruction.

8. The method of claim 6, wherein the machine-readable instructions specify validation of the boundary memory address after the program code is executed.

9. The method of claim 1, wherein the machine-readable instructions include a sequence of instructions with an instruction for storing the boundary memory address in the hardware table, followed by instructions for executing the program code, followed by an instruction for validating the boundary memory address stored in the hardware table.

10. The method of claim 1, wherein the boundary memory address is beyond an extrema in the set of allocated memory addresses.

11. The method of claim 10, wherein the boundary memory address is beyond a maximum in the set of allocated memory addresses.

12. The method of claim 10, wherein the boundary memory address is beyond a minimum in the set of allocated memory addresses.

13. The method of claim 10, wherein the boundary memory address is juxtaposed an extrema in the set of allocated memory addresses.

14. The method of claim 1, wherein the machine-readable instructions include instructions for detecting a memory bounds violation by the program code based on first and second boundary memory addresses stored in the hardware table and respectively delimiting upper and lower boundaries encompassing the set of allocated memory addresses.

15. The method of claim 1, further comprising allocating the set of memory addresses for execution of the program code.

16. The method of claim 15, wherein the allocated memory addresses are contiguous.

17. The method of claim 15, further comprising determining the boundary memory address based on the allocated memory addresses.

18. A machine-readable medium storing machine-readable instructions for causing a machine to:
generate machine-executable code including machine-readable instructions for detecting a memory address bounds violation by the program code based on a determination that a boundary memory address stored in a hardware table has been accessed during execution of the program code, wherein the boundary memory address delimits a boundary for a set of memory addresses allocated for execution of the program code; and
store the machine-executable code in a machine-readable medium.

19. The machine-readable medium of claim 18, wherein the hardware table is designed to contain memory addresses of speculative loads.

20. The machine-readable medium of claim 18, wherein the generated machine-readable instructions include an instruction for storing the boundary memory address in the hardware table.

21. The machine-readable medium of claim 20, wherein the generated machine-readable instructions specify storage of the boundary memory address before the program code is executed.

22. The machine-readable medium of claim 18, wherein the generated machine-readable instructions include an instruction for validating the boundary memory address stored in the hardware table.

23. The machine-readable medium of claim 22, wherein the generated machine-readable instructions specify validation of the boundary memory address after the program code is executed.

24. The machine-readable medium of claim 18, wherein the generated machine-readable instructions include a sequence of instructions with an instruction for storing the boundary memory address in the hardware table, followed by instructions for executing the program code, followed by an instruction for validating the boundary memory address stored in the hardware table.

25. The machine-readable medium of claim 18, wherein the boundary memory address is beyond an extrema in the set of allocated memory addresses.

26. The machine-readable medium of claim 18, wherein the generated machine-readable instructions include instructions for detecting a memory bounds violation by the program code based on first and second boundary memory addresses stored in the hardware table and respectively delimiting upper and lower boundaries encompassing the set of allocated memory addresses.

27. The machine-readable medium of claim 18, further comprising machine-readable instructions for causing a machine to allocate the set of memory addresses for execution of the program code and machine-readable instructions for causing a machine to determine the boundary memory address based on the allocated memory addresses.

28. A machine-implemented method of processing program code, comprising:
storing in a hardware table a boundary memory address delimiting a boundary for a set of memory addresses allocated for execution of the program code;
executing the program code; and
detecting a memory address bounds violation by the program code based on a determination that the boundary memory address stored in the hardware table has been accessed during execution of the program code.

29. The method of claim 28, wherein the hardware table is designed to contain memory addresses of speculative loads.

30. The method of claim 28, wherein the boundary memory address is stored in response to execution of an advanced load instruction in the program code.

31. The method of claim 28, wherein the stored boundary memory address is detected in response to execution of an advanced load check instruction in the program code.

32. The method of claim 28, wherein the program code is executed after the boundary memory address is stored in the hardware table.

33. The method of claim 32, wherein the stored boundary memory address is detected after the program code is executed.

34. The method of claim 28, wherein the boundary memory address is beyond an extrema in the set of allocated memory addresses.

35. The method of claim 34, wherein the boundary memory address is beyond a maximum in the set of allocated memory addresses.

36. The method of claim 34, wherein the boundary memory address is beyond a minimum in the set of allocated memory addresses.

37. The method of claim 28, further comprising executing a prescribed recovery process in response to the detection of a memory address bounds violation.

38. The method of claim 28, further comprising:
storing in the hardware table a second boundary memory address delimiting a second boundary for the set of memory addresses, and
detecting a memory address bounds violation by the program code based on a determination that the second boundary memory address stored in the hardware table has been accessed during execution of the program code;
wherein the first and second boundary memory addresses respectively delimit upper and lower boundaries encompassing the set of allocated memory addresses.

39. The method of claim 38, further comprising executing a prescribed recovery process in response to the detection of a memory address bounds violation based on at least one of the first and second boundary memory addresses.
